(19) United States
(12) Patent Application Publication
(10) Pub. No.: US 2005/0015310 A1
(43) Pub. Date: Jan. 20, 2005

(54) System and method for aggregating and managing client orders using barcode scanning technology

(76) Inventors: Didier Frantz, New York, NY (US); Punit Raizada, Newark, NJ (US)

Correspondence Address: Scanbuy, Inc.;Fourth Floor, 54 West 39th Street, New York City, NY, 10018, US

(21) Appl. No.: 10/823,756

(22) Filed: Apr. 14, 2004

Related U.S. Application Data
(60) Provisional application No. 60/487,238, filed on Jul. 16, 2003.

(51) Int. Cl. G06F 17/60

(52) U.S. Cl. 705/26

(57) ABSTRACT

The present invention discloses a system and method for managing client orders from multiple vendors utilizing barcode scanning technology. Client identification barcodes are utilized to identify each of the user's clients. To order products for a client, a user first scans the client identification barcode using a barcode scanner and then scans the barcodes of the desired products. This process can be repeated for multiple clients. A software program is then utilized to upload the barcode information, create shopping lists, and upload the information to different vendor websites for order completion.

### PARENT CASE TEXT

This application claims the benefit of provisional application No. 60/487,238 filed Jul. 16, 2003.

### FIELD OF THE INVENTION

The present invention relates to the field of managing client accounts and orders using software. More specifically, the present invention provides an improved system and method for aggregating and managing clients' orders using a single software application.

### BACKGROUND

Integrating barcode scanning technology into existing e-commerce websites is painfully long and complex. It requires an extensive integration process and many changes to the e-commerce application-provider. Any user wishing to utilize the barcode scanner services and products would need to first register with the providing company and obtain the required software and hardware. Once they have the software, the user must go through an extensive and sometimes very complicated setup process. Many changes are necessary in tight network configurations in order to allow users to install software on their machines. Also, the software consumes system resources and requires a constant internet connection. These are all factors that contribute to degrade performance of a user's machine unnecessarily.

Existing e-commerce websites desiring to upgrade their websites would need to undergo changes and modifications on their end to handle data being passed to them from this software. The e-commerce website needs to add complex processes in order to handle and parse this data in addition to their current processes. For large e-commerce websites, this can mean causing parts (or even the whole) of their site to be rendered unoperational if not carefully planned and implemented.

The process of ordering using barcode scanners takes the users away from their primary dealer's site. Since this process would generally be handled by a stand-alone software application, there is no relation between the two distinct methods (traditional online ordering and ordering using barcodes). It is very difficult to monitor the environment in which the user is working and entering their order. Since the user's atmosphere is different, there is no correlation in the user's mind regarding this service and the dealer's service; the two methods of ordering appear to be completely separate.

In addition, any changes made to the existing e-commerce platform affects the software application, thus making the software unoperational and useless. This places a very strict limitation as far as services the e-commerce platform can make available to their customers, thereby prohibiting growth.

If a user desires to order from multiple vendors which employ barcode scanning technology on their e-commerce website, the user must typically install a separate application and software for each vendor. Additionally, the barcode scanner require by each vendor may be different, thereby resulting in additional complexity and cost.

For some companies, orders are so voluminous and complex that they often employ an outside company for ordering certain items, such as office supplies. These companies often have multiple clients which requires a great deal of paperwork to track which orders belong to which clients. Also, each client may require supplies from several different vendors which further complicates paperwork and ordering.

Barcode scanning technology may be utilized by these ordering companies to increase the speed at which orders can be placed with some vendors. However, not every vendor may employ barcode scanning technology on their e-commerce website.

Therefore, there clearly exists a need for a system and method which enables users to place orders from multiple vendors using a single software application and barcode scanner. Such a system would allow a vendor to utilize barcode scanning technology to order from multiple vendors without requiring each vendor to employ barcode scanning technology as part of their e-commerce website.

### SUMMARY OF THE INVENTION

The present invention is designed to allow salespeople to take orders from their clients by scanning product codes directly from the client's stockroom. The system allows the user to create and print barcodes for his/her clients. The sales person is the user of the application and can access the application through a user account. The application allows the creation of several user accounts to allow several salespeople to access the application on the same system. Each salesperson can create client accounts for his/her clientele and these accounts can only be accessed by the user account that created them. Each client account is associated with a barcode which can be printed using the application.

In order to process orders for clients the user must scan the barcode for the client followed by the barcodes for the items. The barcode scanner may be any type of barcode scanner which is currently available. The most common type of barcode scanners are laser-based scanners. These scanners have the advantage that they can scan data very quickly. However, these types of scanners are usually only able to decode a few types of barcode formats.

Optical barcode scanners, such as are disclosed in co-pending U.S. Application No. 60/487,237 entitled “ScanZoom,” have the advantage that their decoding is controlled by software. Thus, optical barcode scanners can be programmed to decode almost any type of barcode and can be updated to decode newer barcode formats.

Additionally, if a mobile device is utilized as a barcode scanner, the scanned barcode information can later be transmitted to the processing application wirelessly, thereby eliminating the need to connect the barcode scanner directly to the computer.

The application allows the user to upload all the orders in a single click. The uploaded items can be reviewed in the temporary shopping cart in the application where they are displayed in a categorized manner based on the client. The user can then choose to add the orders to the shopping cart at the vendors' websites one by one or add all the orders in a single click by using the Quick Cart feature.

The Quick Cart feature allows the user to send the products scanned for each client to their respective shopping carts in a single click. This opens up the default browser windows one for each client with the shopping cart of the client displayed.

The present invention also provides the user the ability to manage and print lists of items. The lists are generated on-the-fly by the software.

The present invention can also be adapted to work with Radio Frequency Identification (“RFID”) labeling systems. In this scenario, the barcode scanner would simply be replaced with a RFID scanner. The only other change to the system that would have to occur is that the barcode information contained in the product databases would have to be replaced with the corresponding RFID tag information. A similar process can be utilized to allow the system of the present invention to function with any tagging or labeling system available or which may become available.

Therefore, it is an object of the present invention to provide a client management system for managing orders from multiple clients utilizing a single application.

It is an additional object of the present invention to provide an ordering system which can utilize the standard barcodes located on most products for ordering.

Another object of the present invention is to provide a client management system capable of utilizing both standard and proprietary barcode formats.

It is yet another object of the present invention to provide a client management system which requires minimum modification of the vendors' existing e-commerce website.

An additional object of the present invention is to provide a client management system which uses clients' predetermined preferences to automatically sort products and place orders with different vendors.

It is an additional object of the present invention to provide a client management system which is able to create a shopping cart list for multiple client orders in real time.

These and other objects of the present will be made clearer with reference to the following detailed description and accompanying drawings.

### BRIEF DESCRIPTION OF THE DRAWINGS

FIG. 1 depicts the system architecture for use with the preferred embodiment of the invention.

FIG. 2 depicts a flowchart showing the steps utilized for scanning and order processing in the preferred embodiment of the invention.

FIG. 2A depicts an expanded flowchart of the step utilized to replace quantity barcodes shown in FIG. 2.

FIG. 2B depicts an expanded flowchart of the vendor designation step shown in FIG. 2.

FIG. 3 depicts an alternate embodiment of the present invention in which client identification barcodes and vendor identification barcodes are utilized.

### DETAILED DESCRIPTION OF THE PREFERRED EMBODIMENT(S)

The following presents a detailed description of a preferred embodiment (as well as some alternative embodiments) of the present invention. However, it should be apparent to one skilled in the art that the described embodiment may be modified in form and content to be optimized for a wide variety of situations.

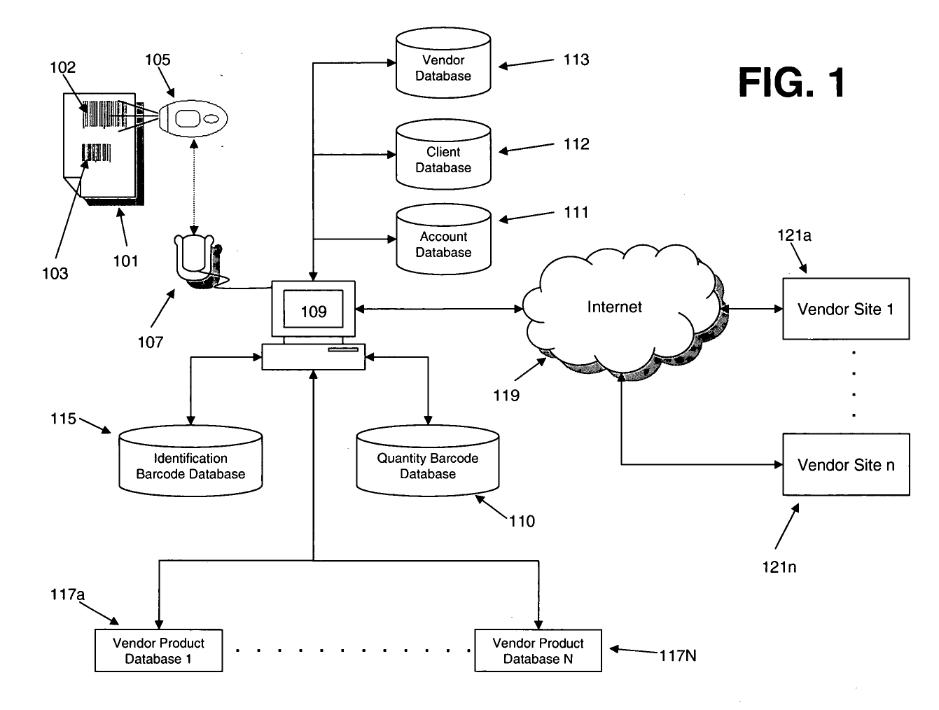

Referring first to FIG. 1, shown is a system diagram depicting the hardware configuration for use with the preferred embodiment of the present invention. In this figure, data carrier 101 is shown containing barcodes 102 and 103. Barcode 102 is a client identification barcode which is assigned to each client by the user. Barcode 102 is chosen to allow the software to later be able to identify which orders belong to which client. Barcode 103 is typically a barcode encoded with a standard symbology (e.g., UPC, ISBN, etc.) which and may either be a one or two-dimensional barcode. However, it should be apparent to one skilled in the art that barcode 103 may be any machine readable code. A user utilizes scanner 105 to scan barcodes 102 and 103. Scanner 105 converts the barcode information into a string of characters which is recognizable by a computer.

Scanner 105 may be any type of scanner capable of scanning barcodes. The most widely used type of barcode scanners are laser-based scanners which are adapted to scan one-dimensional barcodes. Barcode scanners designed to scan two-dimensional barcodes are also currently available but are more expensive than their one-dimensional counterparts.

Scanner 105 may also utilize scanners which use “optical intelligence” which is described in co-pending U.S. Provisional Application No. 60/487,237. Optical intelligence allows any device (mobile or stationary) equipped with a digital camera to function as a barcode scanner.

Cradle 107 is used to connect scanner 105 to computer 109. Alternatively, scanner 105 may connect directly to computer 109 via a direct cable connection using one of computer 109's available ports (e.g., serial, USB, etc.). Scanner 105 may also utilize a wireless connection to connect to computer 109. For example, in the case where scanner 105 is a mobile device utilizing optical intelligence, such as a camera phone, all of the barcode information can be transmitted to computer 109 wirelessly utilizing a wireless connection (Bluetooth, WiFi, cellular network, etc.). Computer 109 contains the software which reads the information from barcode scanner 105 and correctly processes it.

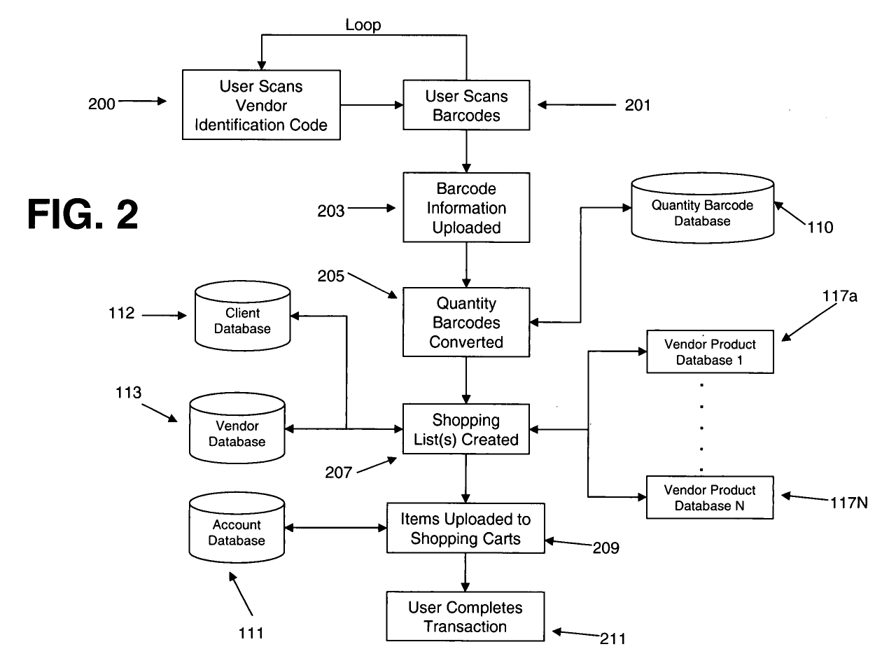

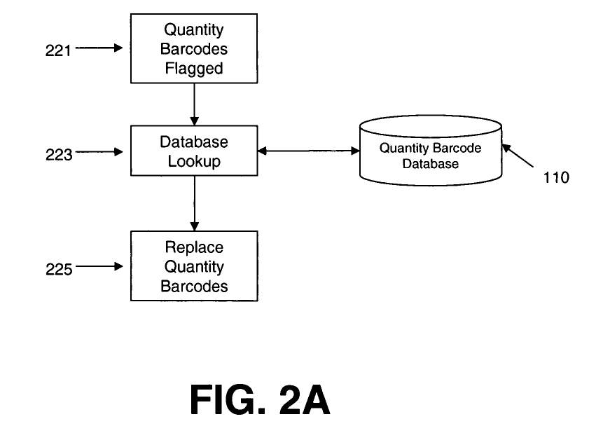

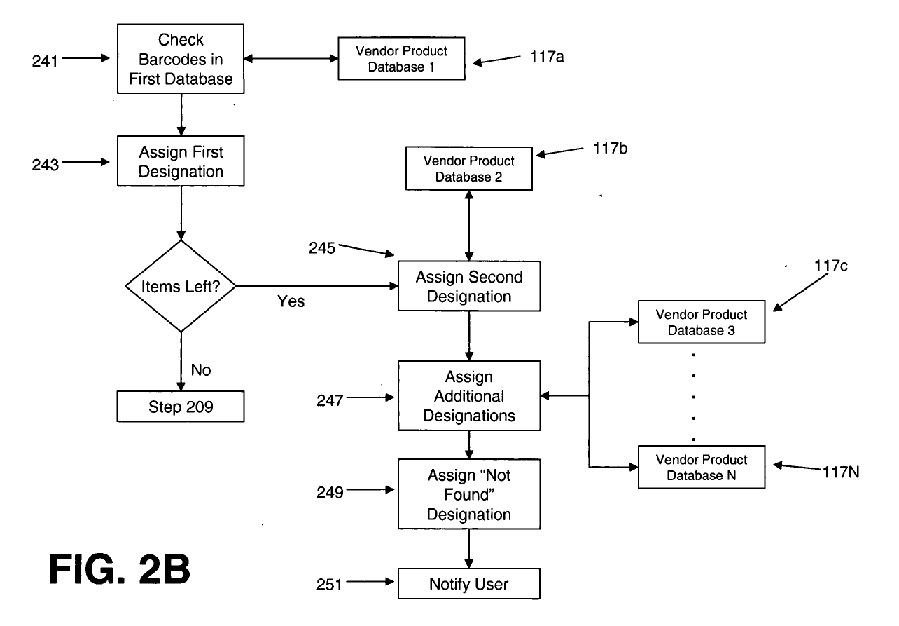

To function properly, the barcode processing software located on computer 109 requires the use of one or more databases. As shown in FIG. 1, computer 109 contains quantity barcode database 110, individual account database 111, client database 112, vendor database 113, identification barcode database 115, and vendor product database 117. Quantity database 110 is a lookup table which indicates the sum to which each quantity barcode corresponds. Account database 111 stores the login information of the user required to access each of the selected vendor's website for each client. Client database 112 identifies the client identification barcode which corresponds to each client. Vendor database 113 is a database which stores the information required to access each vendor's website. Vendor identification barcode database 115 contains information required by the software to decode the quantity scanned from quantity barcodes. Vendor product databases 117a-117n contain a list of the products and associated barcode numbers for each product of each vendor. The function and purpose of each database in the processing of the information acquired via scanner 105 will be described in FIG. 2.

Internet 119 is used to connect computer 109 to vendor websites 121a-121n which allow for the aggregate ordering. The internet connection may either be permanent, such as a DSL or cable connection, or provided through a modem.

Next referring to FIG. 2, shown is a flowchart depicting the steps utilized for aggregate ordering in the preferred embodiment of the present invention. In the preferred embodiment, a user first scans the client identification barcode of the first client to be serviced in step 200. The client identification barcode is a unique barcode which is assigned to each client in the system of the present invention.

After the client identification barcode has been scanned, the user scans all of the products the user wishes to order in step 201 using barcode scanner 105. To accomplish this, the user can either scan the standard barcodes which are located on most products or the user can utilize special catalogues provided by different vendors which contain the printed barcode of each item next to each product. If more than one quantity of a certain product is desired, a user may utilize quantity barcodes to indicate the desired quantity of items. Quantity barcodes are utilized by first scanning the barcode of the product and then scanning the quantity barcode(s).

Once all of the products have been scanned in step 201, the user uploads the scanned barcode information to computer 109 in step 203 utilizing cradle 107. Alternatively, scanner 105 could be connected directly to computer 109 through a wired or wireless connection. The software located on computer 109 facilitates the uploading of the barcode information by synching scanner 105 with computer 109. The barcode information is uploaded to the computer as a character string, wherein different portions of the character string correspond to the different barcodes scanned.

If RFID tags are utilized instead of barcodes, scanner 105 would be a RFID scanner. The process of uploading the information to computer 109 would occur in a similar manner to uploading barcode information.

After the barcode information has been uploaded to computer 109, the software next processes the quantity barcodes in step 205. As shown in FIG. 2A, the software first searches the uploaded barcode information for all instances of quantity barcodes in step 221 and flags the results. The software next-uses quantity barcode database 110 to associate each quantity barcode with a particular sum in step 223. The software then systematically replaces each quantity barcode with the number of copies of the product barcode which immediately precedes it in step 225. For example, if the software found a barcode for a heavy-duty stapler followed by a quantity barcode indicating a quantity of five, the software would replace the quantity barcode with four additional copies of the barcode for the heavy-duty stapler.

Referring back to FIG. 2, the software next creates a shopping list for each of the clients. The software does this by first scanning the uploaded barcode information for the first two occurrences of client identification barcodes. All of the items which are contained between these two barcodes are added to a shopping cart list assigned to the first client. Then, for each barcode in the shopping list, the software assigns it to a particular vendor based upon the user's predetermined vendor preferences in step 207. The order of preference for the vendors is stored in vendor database 113. The software accomplishes this by processing each barcode individually. As shown in FIG. 2B, each of the barcodes is first checked to see if it is located in the first preferred vendor product database 117a in step 241. All of the barcodes found located in database 117a are assigned a designation to indicate that the items correspond to the first preferred vendor in step 243. If all of the barcodes are found in the first preferred vendor database 117a, the software proceeds to step 209. However, if some barcodes are not found, the software next searches second preferred vendor database 117b and assigns a second designation to the items found in that database which were not found in the first preferred vendor database 117a. This process is repeated using the list of preferred vendors until each of the uploaded barcodes has been assigned a designation in step 247. The products which could not be found in any database are assigned a “not found” designation in step 249. The software then displays a message to the user which indicates which products could not be located in step 251. This process is then repeated to create a shopping cart list for each client.

To allow the system of the present invention to function with a RFID tagging system, the barcode information in vendor databases 117a-117n simply has to be replaced with the corresponding RFID information.

Next, referring back to FIG. 2, the software sends each item on the clients' shopping lists to the appropriate vendors' e-commerce websites 121a-121n using XML via Internet 119 in step 109. Currently, XML is the standard method of transmitting such information. However, it should be apparent to one skilled in the art that additional methods of transmitting such information will become available and can be utilized with the present invention. If login or account information is required by some vendors, the software utilizes vendor account database 111 to transmit the login information along with the shopping cart list. A web browser is opened for each the e-commerce websites utilized. The shopping cart of each website is displayed populated with the uploaded items and corresponding quantities.

The user may then complete the ordering in step 211 by confirming that each shopping cart has the correct items and quantities. Typically, the e-commerce websites can be used to add/remove items and/or change quantities if the user desires. Once the user is satisfied with each shopping cart list, the user may execute the order on each e-commerce website.

The software application of the present invention also allows a user to create and store lists of items which a client orders repeatedly. The lists for user accounts can be created on the fly using the software of the present invention. The application allows the user not only to create and modify the lists on the client's behalf but also allows the user to view and modify the existing lists of the client.

The user can also use the software to print the lists in the desired format. To accomplish this, the application sends the list to a system server that prints the list in the desired format and displays the list to the user on the user's system. The user can print the list from his system. The lists can also be sent to the shopping cart on the dealer's website for the client account.

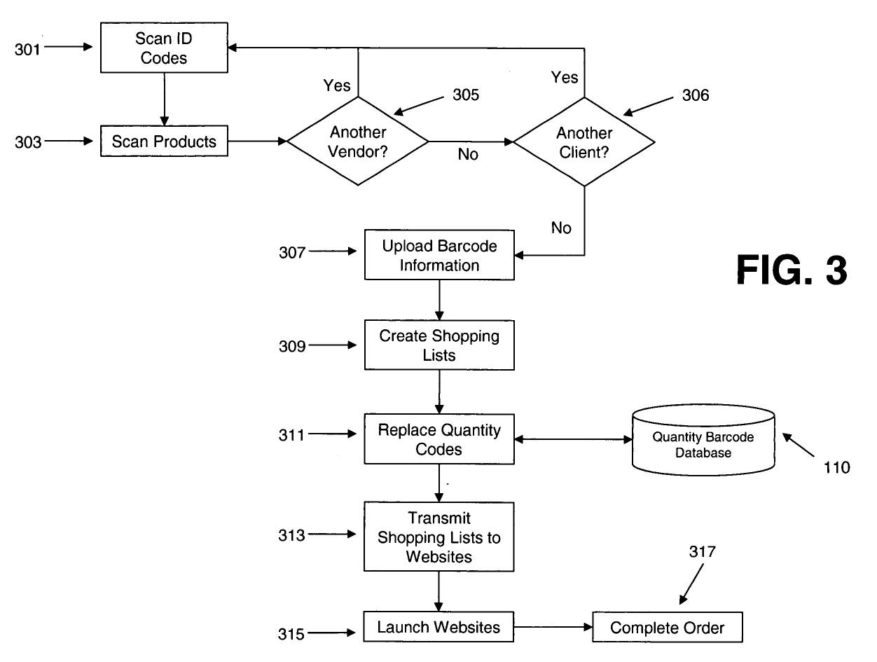

Referring next to FIG. 3, shown is an alternate embodiment of the present invention in which vendor identification barcodes are utilized in addition to client identification barcodes. To utilize this embodiment requires that the user first must obtain catalogues from all of the vendors from which the user desires to order products. In each catalogue, a barcode is provided next to the display or description of each item. The barcode can either be a proprietary barcode assigned to each item by the vendor or it may be the standard barcode which is assigned to each product (e.g., UPC, ISBN, etc.).

The user must also install the software of the present invention on his/her computer and acquire a barcode scanner. For some vendors, the user must input a username and password into the program so that the software program can later connect to that particular vendor's website. This information is stored in vendor account database 111.

Once the user has acquired the correct catalogues and barcode scanner and installed the software, the user is ready to utilize the system of the present invention. First, utilizing scanner 105, the user scans the client identification barcode assigned to the user's current client in step 300. The user then scans the vendor identification barcode of the first vendor in step 301. The vendor identification barcode may be printed directly on the catalogue or on any data carrier capable of being scanned by barcode scanner 105. Next, the user scans all the products from the vendor's catalogue which the client desires to order in step 303. To order multiple quantities of a single item, the user can scan the barcode multiple times or the user can first scan the product barcode and then a quantity barcode. For example, to order fifteen quantities of a particular product, the user would first scan the barcode related to the product, scan a quantity barcode indicating a quantity of ten, and then scan a quantity barcode indicating a quantity of five.

A user may also order items from a particular vendor by scanning the standard barcodes (e.g., UPC-A, UPC-E, ISBN, etc.) located on most products. For example, if a user could not find the entry for a particular soft drink in the vendor's catalogue, the user could scan the UPC barcode directly off of the soft drink itself.

After the user has scanned all of the desired products for the first vendor, the user next scans the identification barcode of the next vendor in step 305. The user may then scan all of the products which the user desires to order from the second vendor. This process is repeated for each vendor through which the user desires to place an order. If the user must order products for another client as decided in step 306, the user simply scans the next client identification barcode in step 301 and repeats the ordering process.

Once the user has scanned all the desired products for ordering, the user connects scanner 105 to computer 109 and launches a software application to upload the barcode information in step 307. Depending upon the specific type of scanner and/or software application, the barcode information may be automatically acquired by the software program or the user may have to initiate a manual upload. The software application then separates the barcode information according to each vendor and creates a shopping list for each client in step 309. The vendor identification barcodes are used to assign a designation to each item in the shopping list to identify which products should be ordered from which vendor.

Next, in step 311, the software program replaces the quantity barcodes in each shopping list utilizing the procedure already described in FIG. 2A. The software application then sends each shopping list to each vendor's e-commerce website in step 313 via XML (XML is the standard by which most e-commerce websites communicate such types of information). A web browser is then launched on computer 109 showing each shopping cart fully populated with the scanned items in step 315. The user may then review the shopping cart of each vendor and click “order” or “purchase” once the user has verified each order is correct in step 317. This process is advantageous because it does not require the utilization of a multitude of vendor product databases 117 which may take a great deal of memory to store depending upon the size of each database.

While the foregoing embodiments of the invention have been set forth in considerable detail for the purposes of making a complete disclosure, it should be evident to one skilled in the art that multiple changes may be made to the aforementioned description without departing from the spirit of the invention.

1. A method for aggregating and managing client orders comprising the steps of:
scanning at least one client machine readable code with a scanner;
scanning at least one product machine readable code with said scanner,
transmitting said scanned client machine readable codes and said product machine readable codes stored in said scanner to a computer;
creating a shopping list for each client and each vendor by using said client machine readable code to identify the owner of the shopping cart and by using a predetermined vendor preference list stored on said computer to assign each product machine readable code to a different vendor shopping list for each client;
transmitting said shopping lists to the appropriate e-commerce website operated by said designated vendor for each client; and
completing the aggregate ordering for each client by placing the order for each client using each of said e-commerce websites.

2. A method for aggregating and managing client orders according to claim 1, wherein said product machine readable code is a barcode.

3. A method for aggregating and managing client orders according to claim 1, wherein said product machine readable code is a RFID tag.

4. A method of aggregate ordering according to claim 2, wherein said product machine readable code is constructed from at least one of the standardized barcode symbology libraries consisting of the group of UPC-A, UPC-E, ISBN, RSS-14, RSS-14E, RSS-14L, Interleaved 2 of 5, EAN/JAN-8, EAN/JAN-13, Code 3, Code 39 Full ASCII, Code 128, PDF417, QR Code, or Data Matrix.

5. A method of aggregate ordering according to claim 1, wherein said step of creating shopping lists comprises the steps of:
identifying the first client machine readable code from said uploaded information;
creating a first vendor shopping list for said first client by placing all product machine readable codes found in a first preferred vendor database to said first vendor shopping list;
creating additional shopping lists for each vendor for said first client by utilizing a plurality of preferred vendor databases in an assigned order; and
creating shopping lists in the same manner for each additional client.

6. A method for aggregating and managing client orders to claim 1, wherein said scanner is a laser-based barcode scanner.

7. A method for aggregating and managing client orders according to claim 1, wherein said scanner utilizes optical recognition techniques.

8. A method for aggregating and managing client orders according to claim 1, wherein said scanner is a RFID scanner.

9. A system for aggregating and managing client orders comprising:
at least one client machine readable code;
at least one product machine readable code
a scanner capable of scanning said client machine readable codes and said product machine readable codes;
a computer for connecting to said scanner to upload said client machine readable codes and product machine readable codes;
a software application located on said computer which creates a shopping list for each client and each vendor by using said client machine readable code to identify the owner of the shopping cart and by using a predetermined vendor preference list stored on said computer to assign each product machine readable code to a different vendor shopping list for each client, transmits said shopping lists to the appropriate e-commerce website operated by said designated vendor for each client, and completes the aggregate ordering for each client by placing the order for each client using each of said e-commerce websites.

10. A system for aggregating and managing client orders according to claim 9, wherein said product machine readable code is a barcode.

11. A system for aggregating and managing client orders according to claim 9, wherein said product machine readable code is a RFID tag.

12. A system for aggregating and managing client orders according to claim 10, wherein said barcode is constructed from at least one of the standardized barcode symbology libraries consisting of the group of UPC-A, UC-E, ISBN, RSS-14, RSS-14E, RSS-14L, Interleaved 2 of 5, EAN/JAN-8, EAN/JAN-13, Code 3, Code 39 Full ASCII, Code 128, PDF417, QR Code, or Data Matrix.

13. A system for aggregating and managing client orders according to claim 9, wherein said scanner is a laser-based barcode scanner.

14. A system for aggregating and managing client orders according to claim 9, wherein said scanner utilizes optical recognition techniques.

15. A system for aggregating and managing client orders according to claim 9, wherein said scanner is a RFID scanner.
